(19) United States
(12) Patent Application Publication
(10) Pub. No.: US 2005/0128575 A1
(43) Pub. Date: Jun. 16, 2005

(54) Microscope stage contrasting means

(75) Inventors: Russell Bonaventura, Williamsville, NY (US); Wayne A. Buttermore, Chicago, IL (US); David J. Cash, Depew, NY (US); John Levin, Beaverton, OR (US)

Correspondence Address: S. Peter Konzel, Esq.;Simpson & Simpson, PLLC, 5555 Main Street, Williamsville, NY, 14221-5406, US

(73) Assignee: Leica Microsystems Inc., Buffalo, NY (US)

(21) Appl. No.: 10/733,628

(22) Filed: Dec. 11, 2003

(51) Int. Cl. G02B 21/26

(52) U.S. Cl. 359/391; 359/398

(57) ABSTRACT

A microscope stage includes a contrasting stage insert for providing contrast between a microscope stage and a specimen. The microscope stage insert has a color that is different from the color of the specimen. In a preferred embodiment, an upper stage includes a first color and a recess operatively arranged for receiving a removable complementary shaped contrasting stage insert therein. The contrasting stage insert has a second color that is different from the color of the upper stage, and more preferably, the specimen. The contrasting stage insert is configured for removable complementarily receipt in the recess.

### FIELD OF THE INVENTION

The present invention relates generally to microscopes, and more particularly, to a contrasting means for a microscope stage that allows a user to orient a specimen thereon prior to insertion of the specimen into the optical path.

### BACKGROUND OF THE INVENTION

Microscope stage assemblies typically comprise flat black upper stage surfaces for a variety of reasons. One reason is that flat black microscope upper stage surfaces are aesthetically appealing. A second, more functionally related reason is that the flat black upper stage surface serves to absorb incident light and functions to prevent light from being reflected from the stage and into the optical path. A problem associated with black microscope upper stage surfaces, however, is the fact that it can often be difficult to properly orient a specimen on the surface of the stage prior to inserting the specimen into the optical path. This difficulty is primarily attributed to the fact that specimens are usually prepared on clear glass slides and are stained with dark colored pigments. Consequently, because the stained specimen is stained a dark color and because the upper stage surface of the microscope is black, it can be difficult to properly orient a specimen prior to placing it in the optical path. Simply put, there is not enough contrast between the dark hued specimen, the glass slide and the black upper stage surface in order for the user to see the specimen so as to properly orient it. As a result, users typically place the specimen under the objective and peer through the eyepiece in order to properly orient the specimen. Orienting a specimen in this manner can be difficult under high magnification, can be time consuming, and can be extremely frustrating. Additionally, while a black upper stage surface typically comprises the preferred color of a microscope's upper stage, similar problems can occur where an upper stage comprises a color other than flat black and little contrast exists between the specimen and the upper stage surface.

What is needed then is a microscope stage including means for creating contrast between a microscope stage and a specimen such that the specimen may be properly oriented upon the stage prior to insertion into the optical path.

### SUMMARY OF THE INVENTION

The present invention broadly comprises a device for providing contrast between a microscope stage and a specimen and generally includes a microscope stage having an upper stage comprising an optional contrasting stage insert. The upper stage generally comprises a first background color and the contrasting stage insert typically comprises a second contrasting color. Additionally, the color of the contrasting stage insert is different from the color of the specimen such that contrast between the specimen and the contrasting stage insert is provided. In a preferred embodiment, the upper stage includes a recess operatively arranged for receiving a complementary shaped and removable contrasting stage insert therein.

Thus, a primary object of the present invention is to provide a means for providing contrast between a specimen and a microscope stage;

Another object of the invention is to provide a contrasting stage insert for a microscope stage such that contrast between a specimen and a microscope stage may be provided;

A further object of the invention is to provide a microscope stage having a recess therein for complementarily receiving a removable stage insert wherein the insert contrasts with a specimen.

These and other objects, features and advantages of the invention will become readily apparent to one having ordinary skill in the art upon study of the following detailed description in view of the drawings and appended claims.

BRIEF DESCRIPTION OF THE DRAWINGS

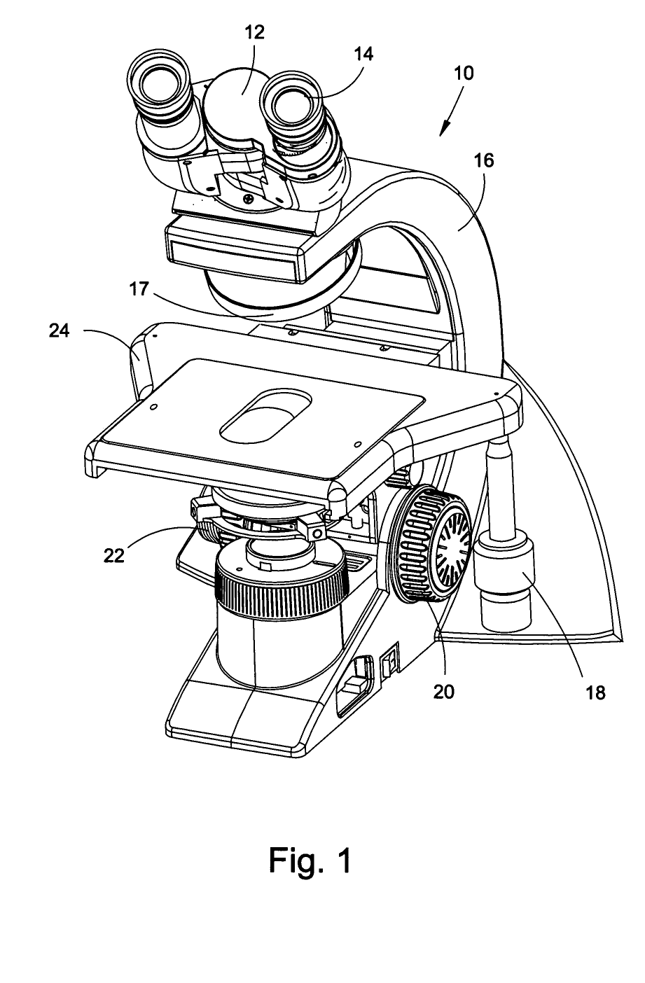

FIG. 1 is a perspective view of a microscope comprising a microscope stage contrasting means according to the present invention;

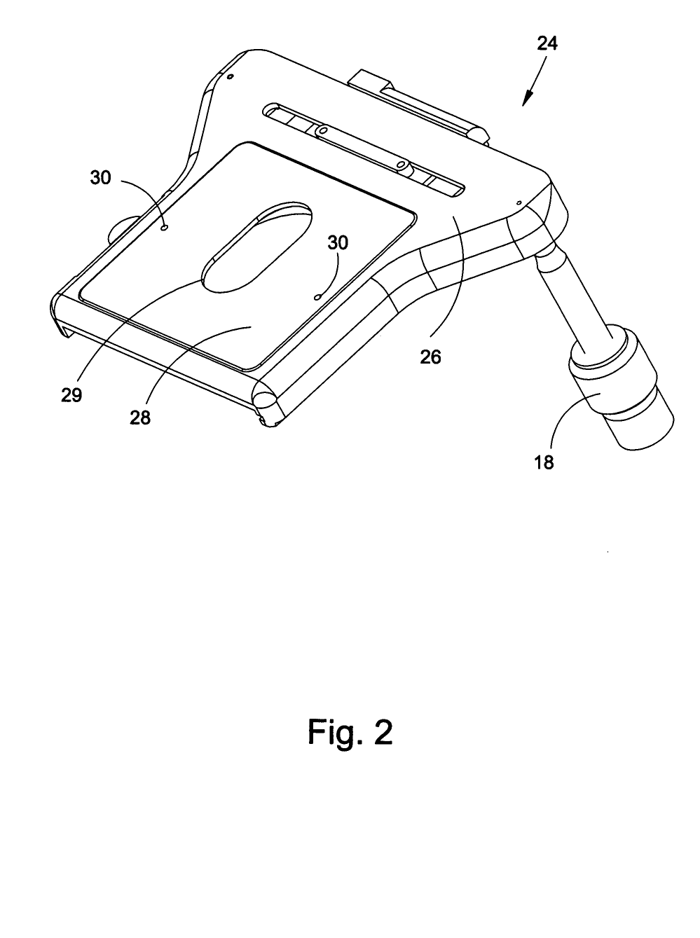

FIG. 2 is a perspective view of a microscope stage according to the present invention;

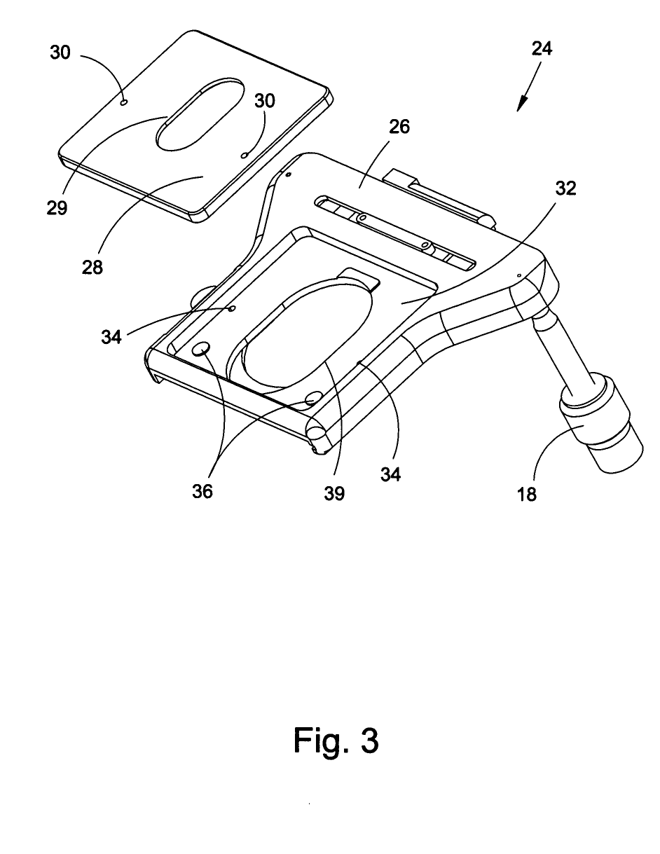

FIG. 3 is an exploded perspective view of the microscope stage of FIG. 2;

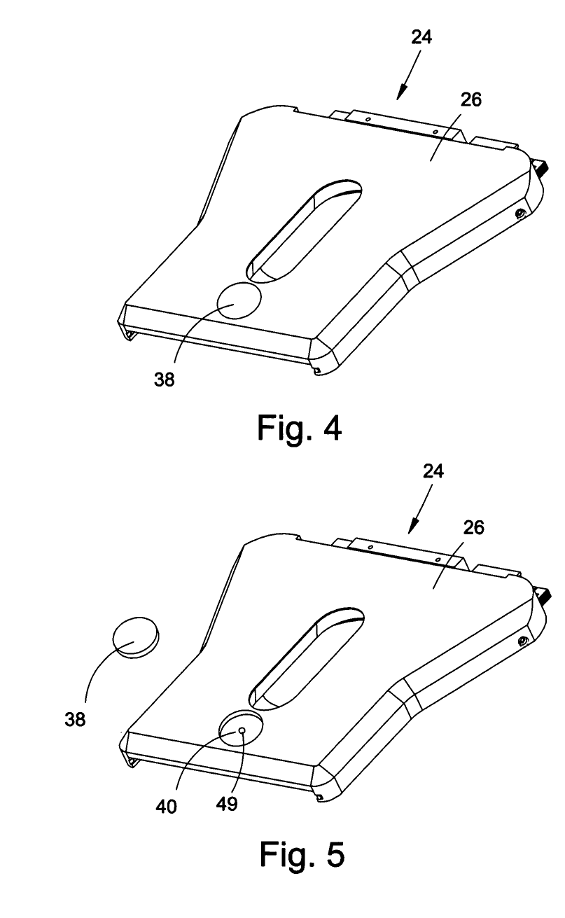

FIG. 4 is perspective view of an alternative embodiment of the microscope stage of the present invention;

FIG. 5 is an exploded perspective view of a the embodiment of FIG. 4;

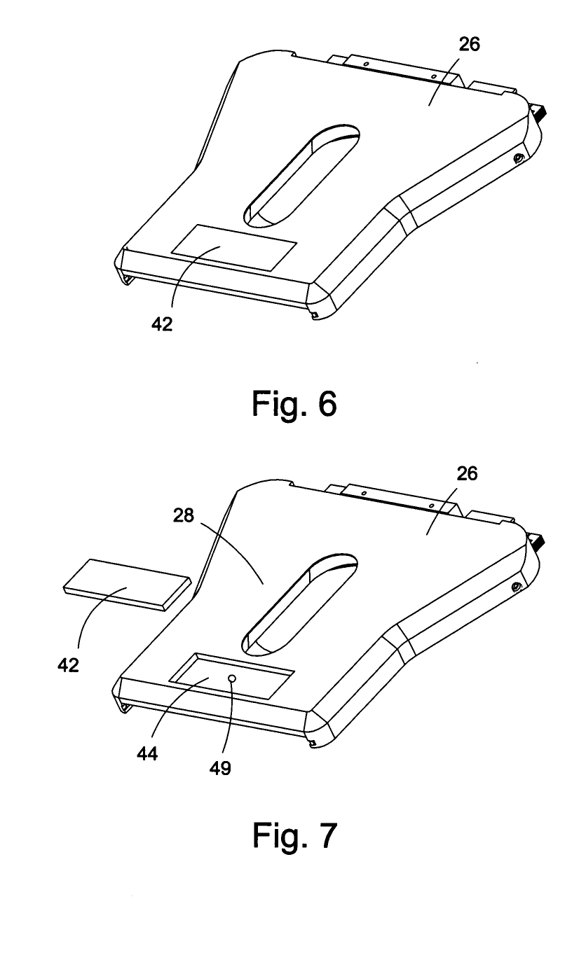

FIG. 6 is a perspective view of a further embodiment of the microscope stage of the present invention;

FIG. 7 is an exploded perspective view of the microscope stage of FIG. 6;

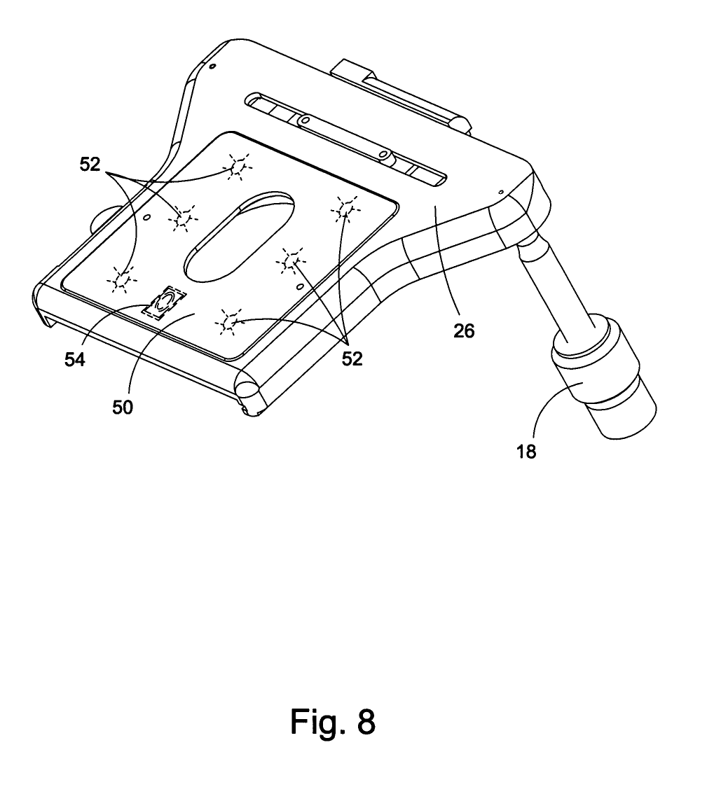

FIG. 8 is a perspective view of an embodiment of the present invention comprising an illuminable contrasting stage insert; and,

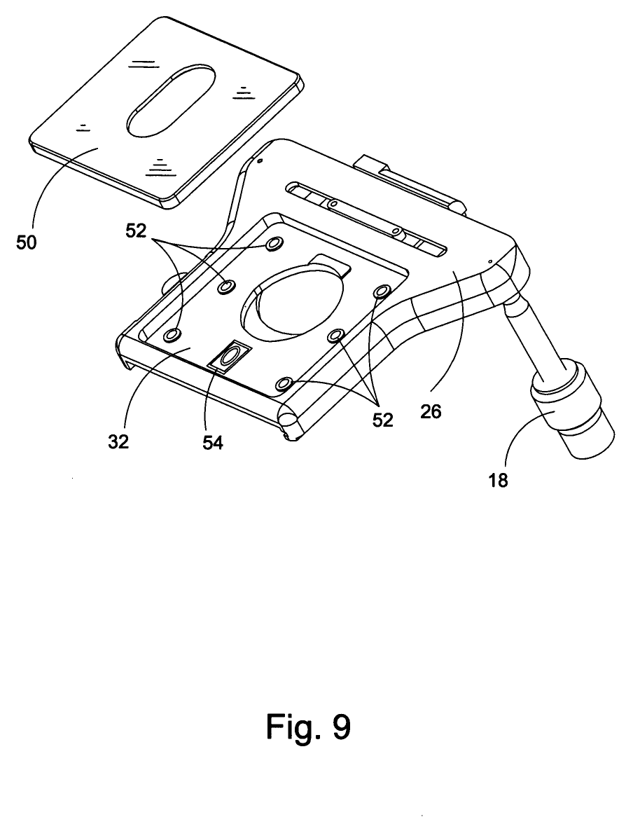

FIG. 9 is an exploded perspective view of the microscope stage of FIG. 8.

### DETAILED DESCRIPTION OF THE PREFERRED EMBODIMENT

At the outset, it should be appreciated that like reference numbers on different drawing figures represent similar structural elements. It should also be appreciated that, while a number of different embodiments and variations of the present invention are shown in the various drawings, the invention as claimed is not intended to be limited to these specific embodiments as the claims define a broader invention that can take many different shapes and structures. Additionally, while it is preferable to use the present invention in association with the stage drive control described in “Interchangeable Microscope Stage Drive Assembly”, filed concurrently herewith and incorporated herein by reference, or with the stage movement means as described in “Microscope Stage Apparatus and Movement Means”, filed concurrently herewith and incorporated herein by reference, or with the interchangeable fine adjustment knob described in “Interchangeable Microscope Fine Adjustment Means”, filed concurrently herewith and incorporated herein by reference, the present invention may be used in association with virtually any type of microscope and is not intended to be limited to the specific microscope disclosed in the present specification and disclosure. Finally, in the present disclosure and claims, it should be appreciated that the terms “insert” and/or “plate” are not intended to be limited to the removable platelike structures as illustrated in the present Figures, but may include semi-permanent surfaces such as painted surfaces, adhesive films, colored magnets, etc. or other means for providing contrast between a specimen and the contrasting stage insert described herein.

Adverting now to the Figures, FIG. 1 broadly illustrates microscope 10 as comprising binocular head 12, eyepiece 14, stand 16, objective turret 17, stage drive control 18, coarse focus adjustment knob 20, fine focus adjustment knob 22 and stage assembly 24. Stage assembly 24 is generally left/right and forward/backward adjustable via stage drive control 18 and stage drive means (not shown).

Referring now to FIGS. 2 and 3, stage assembly 24 of the present invention broadly comprises upper stage 26, which additionally includes contrasting stage insert 28. In a preferred embodiment upper stage 26 is black, and more preferably flat black, for purposes of limiting the incidence of light that may be reflected off of the stage and into the optical path. The upper stage could, however, comprise another color if desired. Typically, the upper stage comprises aluminum that is anodized and painted to provide a flat black color. Optional stage insert 28 is preferably made of stainless steel and is of a lighter color than upper stage 26. The contrasting stage insert is, thus, configured for providing contrast between a specimen and the contrasting stage insert when the specimen is placed thereon. In a preferred embodiment, because most specimen stains comprise dark red, blue, and/or purple dyes, the contrasting stage insert may comprise a white color and/or a non-reflective surface, for example, as may be provided by a powder coating. It should be appreciated, however, that while a preferred embodiment comprises a contrasting stage insert having a white or light color, the contrasting stage insert could comprise other colors for affecting the level of contrast between the contrasting stage insert and a specimen. Contrasting stage insert 28 also comprises aperture 29, which allows light to pass therethrough for performing microscopy methods.

As shown more clearly in FIG. 3, the stage assembly of the present invention is operatively arranged such that contrasting stage insert 28 is removable from upper stage 26. In such embodiment, upper stage 26 comprises recess 32, which is configured for accepting complementarily shaped contrasting stage insert 28, which in this embodiment is removable from the upper stage. For purposes of properly aligning the contrasting stage insert therein, recess 32 comprises alignment means 34, which may comprise a pair of pins or nubs operatively arranged for mateable fit with bores 30 of the contrasting stage insert. Of course, other means for ensuring the proper alignment of contrasting stage insert 28 within recess 32 are contemplated, for example, notches, keyways or the like could be utilized to ensure proper mate of the contrasting stage insert and the recess. FIG. 3 also illustrates that recess 32 further comprises fastening means 36 for securing the contrasting stage insert within the recess. Fastening means 36 may comprise magnets, hook and loop type fasteners, detents, springed ball bearings, or the like. Finally, recess 32 comprises aperture 39, which is larger than aperture 29 of the contrasting stage insert such that the contrasting stage insert may be readily removed from the recess from below the upper stage.

Referring now to FIGS. 4-7, the stage assembly of the present invention may also be configured to comprise virtually any other size or shape of contrasting stage insert, as well as contrasting stage inserts made from a wide range of materials. For example, FIGS. 4 and 5 illustrate that contrasting stage insert 38 may comprise a circularly shaped insert 38 operatively arranged for receipt within circular recess 40 of upper stage 26, whereas FIGS. 6 and 7 illustrate that rectangular contrasting stage insert 42 is operatively arranged for mateable receipt within rectangular recess 44. Contrasting stage inserts 38 and 42 may be releasably fastened within their respective recesses via magnets, hook and loop type fasteners, detents, springed ball bearings, or the like, and removed therefrom by means of apertures 49 from below the upper stage surface. In the embodiments of FIGS. 4 through 7, upper stages 26 typically comprise aluminum that has been anodized and painted to create a flat black surface and contrasting stage inserts 38 and 42 generally comprise a light color, such as white, for providing contrast between a specimen and the contrasting stage inserts. Contrasting stage inserts 38 and 42 may be constructed from a range of materials that include, but are not limited to: metals, coated metals, plastics, ceramics, etc., or the like, if desired. Contrasting stage inserts 38 and 42 may also be configured to be solid, hollow, translucent or opaque. Additionally, a set of contrasting stage inserts 38 and 42 may be provided in a wide range of colors or contrasts such that various levels and/or ranges of contrast between a specimen and the stage contrasting inserts may be provided as appropriate. Alternatively, the upper stage could comprise a plurality of inserts having various levels of color or contrast.

In particularly preferred embodiments, the contrasting stage insert may comprise solid or hollow materials that are translucent such that the contrasting stage insert may be backlit for purposes of illuminating a specimen prior to inserting the specimen into the optical path.

As shown in FIGS. 8 and 9, a stage assembly is illustrated as comprising translucent contrasting stage insert 50, which is backlit by at least one light emitting diode (LED) 52, and a pressure sensitive switch 54 for switching the LED's on an off via an appropriate electronic circuit. In such embodiment, applying pressure to contrasting stage insert 50 serves to toggle pressure sensitive switch 54, which may be spring loaded, such that the LED's disposed below the translucent contrasting stage insert are caused to illuminate. Pressing the contrasting stage insert when the LED's are illuminated causes the LED's to turn off. The pressure sensitive switch and the LED's for producing illumination may be battery powered or powered via the microscope's power source according to an appropriate electronic circuit. It should be appreciated by those having ordinary skill in the art that while an illuminable microscope stage assembly comprising LED's disposed below translucent contrasting stage insert 50 is disclosed herein, other methods of illuminating the contrasting stage insert are contemplated and are encompassed by the present disclosure and claims. For example, illumination means other than LED's may be utilized to illuminate the translucent contrasting stage insert, or other methods of disposing the illumination means within the stage assembly may be utilized, i.e., the illumination means may be disposed within the solid or hollow contrasting stage insert itself such that illumination of the contrasting stage insert is independent of the upper stage. Additionally, the illuminable contrasting stage insert could be adapted to be readily removed from the upper stage or arranged such that different colors or contrasts of illuminable contrasting stage insert could be inserted and removed from the upper stage as desired. Finally, other types of switch for causing the illumination of the illumination means may be utilized, for example, a switch secured to the microscope base, stand, stage, etc. may be utilized.

Finally, while a preferred embodiment of the present invention comprises a removable contrasting stage insert and/or a pressure sensitive switch for providing illumination, it should be appreciated by those having ordinary skill in the art that the contrasting stage insert may comprise a semi-permanent surface such as a painted surface, an adhesive film (a sticker), a magnet, etc.

Thus, it is seen that the objects of the present invention are efficiently obtained, although modifications and changes to the invention should be readily apparent to those having ordinary skill in the art, which modifications are intended to be within the spirit and scope of the invention as claimed.

1. A microscope stage comprising:
an upper stage comprising a first color; said upper stage comprising a recess therein; and
a contrasting stage insert; said contrasting stage insert comprising a second color different from said first color; said contrasting stage insert configured for removable complementarily receipt within said recess.

2. The microscope stage of claim 1 wherein said contrasting stage insert comprises alignment means for aligning said contrasting stage insert within said recess.

3. The microscope stage of claim 2 wherein said alignment means comprises a recess pin and a contrasting stage insert bore.

4. The microscope stage of claim 1 wherein said contrasting stage insert comprises releasable fastening means.

5. The microscope stage of claim 4 wherein said releasable fastening means comprises a magnet.

6. The microscope of claim 4 wherein said releasable fastening means comprises a springed detent.

7. The microscope stage of claim 1 comprising an illuminable contrasting stage insert.

8. The microscope stage of claim 7 wherein said illuminable contrasting stage insert is illuminated by means of at least one LED.

9. A microscope stage comprising:
an upper stage comprising a first color; and
a contrasting stage insert comprising a second color,
said contrasting stage insert comprising a portion of said upper stage background.

10. The microscope stage of claim 9 wherein said contrasting stage insert comprises a painted surface.

11. The microscope stage of claim 9 wherein said contrasting stage insert comprises a magnetic surface.

12. The microscope stage of claim 9 wherein said contrasting stage insert comprises an adhesive film.

13. The microscope stage of claim 9 wherein said upper stage comprises a recess and said contrasting stage insert is operatively arranged for releasable complementary receipt therein.

14. The microscope stage of claim 13 wherein said contrasting stage insert further comprises alignment means.

15. The microscope of claims 13 wherein said contrasting stage insert further comprises fastening means.

16. The microscope of claim 13 wherein said contrasting stage insert is illuminable.

17. A device for providing contrast between a microscope stage and a specimen comprising:
a microscope stage comprising a contrasting stage insert having a first color;
a specimen comprising a second color;
said first color of said contrasting stage insert different from said second color of said specimen.

18. The device of claim 17 wherein said contrasting stage insert is releasably secured to said microscope stage.

19. The device of claim 17 wherein said contrasting stage insert comprises a releasable fastening means.

20. The device of claim 19 wherein said fastening means comprises a magnet.
